(19) United States
(12) Patent Application Publication
(10) Pub. No.: US 2016/0098411 A1
(43) Pub. Date: Apr. 7, 2016

(54) QUERYING INPUT DATA

(71) Applicant: The Regents of the University of Michigan, Ann Arbor, MI (US)

(72) Inventors: Prateek TANDON, Ann Arbor, MI (US); Thomas Friedrich WENISCH, Ann Arbor, MI (US); Michael John CAFARELLA, Ann Arbor, MI (US)

(21) Appl. No.: 14/494,047

(22) Filed: Oct. 3, 2014

(51) Int. Cl. G06F 17/30

(52) U.S. Cl. CPC G06F 17/3066; G06F 17/30675

(57) ABSTRACT

A hardware accelerator 2 for performing queries into, for example, an indexed text log files is formed of plurality of hardware execution units (text engines) 4, each executing a partial query program upon the same full set of input data. These partial query programs may switch between different query algorithms on up to a per-character basis. The sequence of data when loaded into a buffer memory 16 for querying may be searched for delimiters as the data is loaded. The hardware execution units may support a number match program instruction which serves to identify a numeric variable, and to determine a value of that numeric variable located at a variable position within a sequence of characters being queried.

### BACKGROUND

1. Field

This disclosure relates to the field of data processing systems. More particularly, this disclosure relates to querying input data.

2. Background

It is known to provide hardware accelerators for certain processing tasks. One target domain for such accelerators is natural language processing (NLP). The explosive growth in electronic text, such as tweets, logs, news articles, and web documents, has generated interest in systems that can process these data quickly and efficiently. The conventional approach to analyse vast text collections—scale-out processing on large clusters with frameworks such as Hadoop—incurs high costs in energy and hardware. A hardware accelerator that can support ad-hoe queries on large datasets, would be useful.

The Aho-Corasick algorithm is one example algorithm for exact pattern matching. The performance of the algorithm is linear in the size of the input test. The algorithm makes use of a trie (prefix tree) to represent a state machine for the search terms being considered. FIG. 1 of the accompanying drawings shows an example Aho-Corasiek pattern matching machine tor the following search terms, added in order: ‘he’, ‘she’, ‘his’ and ‘hers’. Pattern matching commences at the root of the trie (state or node 0), and state transitions are based on the current state and the input character observed. For example, if the current state is 0, and the character ‘h’ is observed, the next state is 1.

The algorithm utilizes the following information during pattern matching:
Outgoing edges to enable a transition to a next state based on the input character observed.
Failure edges to handle situations where even though a search term mismatches, the suffix of one search term may match the prefix of another. For example, in FIG. 1, failure in state 5 takes the pattern matching machine to state 2 and then state 8 if an ‘r’ is observed.
Patterns that end at the current node. For example, the output function of state 7 is the pattern ‘his’.

Typically, to ensure constant run time performance, each node in the pattern matching machine stores an outgoing edge for all the characters in the alphabet being considered. Therefore, each node has branching factor of N, where N is the alphabet size. For example, for traditional ASCII, the branching factor is 128. However, storing all possible outgoing edges entails a high storage cost. A technique to reduce the required storage through bit-split state machines has been proposed by Tan and Sherwood (L. Fan and T. Sherwood. A High Throughput String Matching Architecture for Intrusion Detection and Prevention. In Computer Architecture, 2005. ISCA '05. Proceedings, 32nd International Symposium on, 2005). The authors propose the splitting of each byte state machine into n-bit state machines. Since the bit state machine only has two outgoing edges for each node, the storage requirement is reduced drastically. Each state in the bit state machine corresponds to one or more states in the byte state machine. If the intersection of all bit state machines maps to the same state in the byte state machine, a match has been found and is reported.

Since regular expression matching involves harder to encode state transitions, transition rules that offer greater degrees of flexibility may be used. Transition rules of the form <current state, input character, next state> can be used to represent state machine transitions for regular expression matching. Van Lunteren et al. (J. Lunteren, C. Hagleitner, T. Heil, G. Biran, U. Shvadron, and K. Atasu. Designing a programmable wire-speed regular-expression matching accelerator. In Microarchitecture (MICRO), 2012 45th Annual IEEE/ACM. International Symposium on, 2012) use rules stored using the technique of balanced routing tables; this technique provides a fast hash lookup to determine next states. In contrast, Bremler-Barr and co-authors (A. Bremler-Barr, D. Hay, and Y. Koral. Compactdfa: Generic state machine compression for scalable pattern matching. In INFOCOM, 2010 Proceedings IEEE, 2010), encode states such that all transitions to a specific state can be represented by a single prefix that defines a set of current states. Therefore, the pattern-matching problem is effectively reduced to a longest-prefix matching problem.

### SUMMARY

Viewed from one aspect this disclosure provides a method of processing data comprising the steps of:
receiving a query specifying a query operation to be performed upon a set of input data;
generating a plurality of partial query programs each corresponding to a portion of said query operation; and
executing each of said plurality of partial query programs with all of said set of said input data as an input to each of said plurality of partial query programs.

Viewed from another aspect this disclosure provides a method of processing data comprising the steps of:
receiving a query specifying a query operation to be performed upon input data;
programming one or more hardware execution units to perform said query, wherein
said step of programming programs said one or more hardware execution units to use selected ones of a plurality of different query algorithms to perform different portions of said query operation upon different portions of said input data.

Viewed from another aspect this disclosure provides apparatus for processing data comprising:
a memory to store a sequence of data to be queried;
delimiter identifying circuitry to identify data delimiters between portions of said sequence of data as said data is stored to said memory; and
a delimiter store to store storage locations of said data delimiters within said memory.

Viewed from another aspect this disclosure provides apparatus for processing data comprising:
programmable processing hardware responsive to a number match program instruction to identify a numeric variable and to determine a value of said numeric variable located at a variable position within a sequence of characters.

Another aspect of the disclosure provides apparatus for processing data comprising:
a receiver to receive a query specifying a query operation to be performed upon a set of input data;
a program generator to generate a plurality of partial query programs each corresponding a portion of said query operation; and
hardware execution circuitry to execute each of said plurality of partial query programs with all of said set of said input data as an input to each of said plurality of partial query programs.

Another aspect of the disclosure provides apparatus for processing data comprising:
a receiver to receive a query specifying a query operation to be performed upon input data;
one or more hardware execution units programmed to perform said query, wherein
said one or more hardware execution units are programmed to use selected ones of a plurality of different query algorithms to perform different portions of said query operation upon different portions of said input data.

Another aspect of the disclosure provides a method of processing data comprising the steps of:
storing in a memory a sequence of data to be queried;
identifying data delimiters between portions of said sequence of data as said data is stored to said memory; and
storing in a delimiter store storage locations of said data delimiters within said memory.

Another aspect of the disclosure provides a method of processing data comprising the steps of:
in response to a number match program instruction executed by programmable hardware, identifying a numeric variable and determining a value of said numeric variable located at a variable position within a sequence of characters.

The above, and other objects, features and advantages of this disclosure will be apparent from the following detailed description of illustrative embodiments which is to be read in connection with the accompanying drawings.

### DRAWINGS

FIG. 1 illustrates an Aho-Corasick state machine;

FIG. 2 illustrates a state machine architecture;

FIG. 3 illustrates example program instructions;

FIG. 4 is a flow diagram illustrating accelerator programming; and

FIG. 5 is a flow diagram illustrating query algorithm selection.

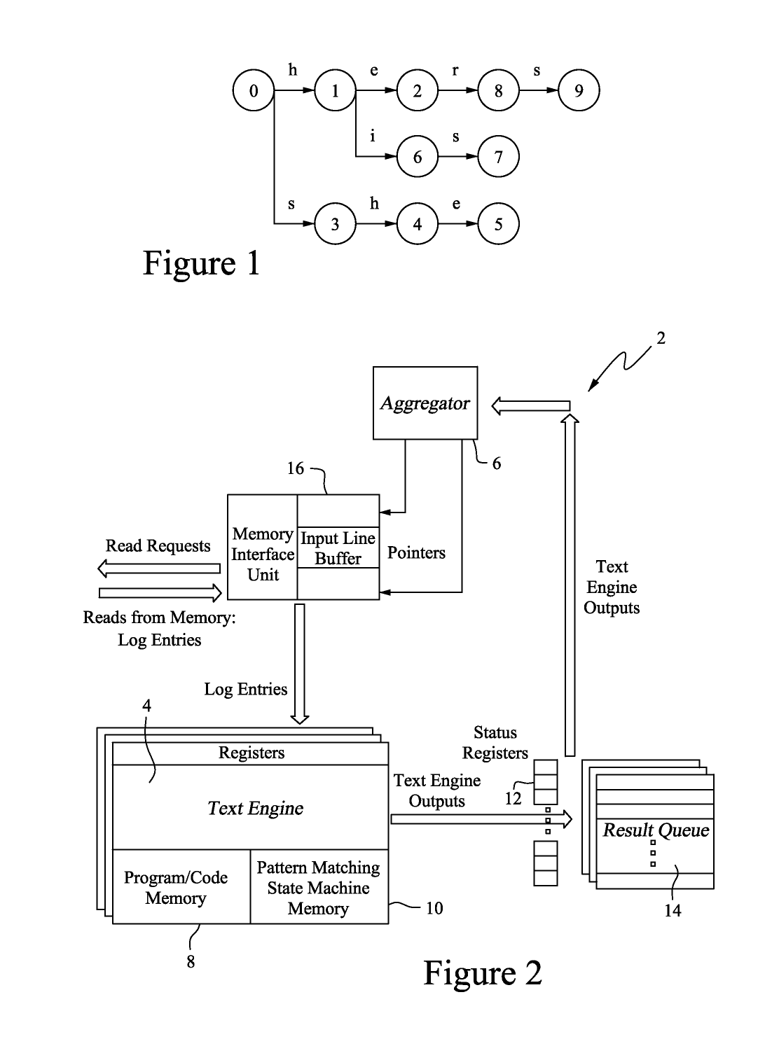

### EMBODIMENTS

FIG. 2 shows the architecture of an accelerator design. The programmable accelerator 2 consists of a set of text engines 4 (TEs) (hardware execution units) which operate upon lines of the input log files and determine whether to accept or reject each line; status registers that list whether the TEs are running, have matched a line successfully, or failed at matching; result queues with 32-bit entries into which the TEs place their results when accepting a line; and, an aggregator 6 that post-processes the results written out by the TEs. User queries are converted into machine code (programs) by a compiler; these compiled queries are assigned to the TEs for further analysis. Compiled programs that do not fit fully within each TE's memory are split (sharded) across multiple TEs.

The compiler takes in user queries and generates programs that run on the text engines 4 (TEs). If a query is very large and entails a program whose size exceeds the TE memory, the compiler distributes the query across multiple programs; these programs are in turn distributed across multiple TEs. In addition to the program(s) associated with each query, the compiler also generates pattern matching state machines that are loaded on to each TE 4. Each pattern matching stale machine is represented as a series of transition rules.

Text engines 4 (TEs) run compiled programs generated by the compiler for user queries. At a high level, each TE 4 consists of dedicated memory areas for programs 8 and pattern matching state machines 10, sixteen 32-bit general purpose registers, and hardware units that are responsible for running the compiled programs associated with user queries. Each TE 4 operates upon one line in the input log file at a time and returns a signal indicating whether the line is accepted or rejected. The aggregator 6 controls pointers (head pointer and tail pointer) into the input stream for each TE 4, and thereby controls availability of new lines; for the TEs 4.

1) Program and Pattern Matching State Machine Memory:

Each TE contains 4 KB of program memory 8 and 8 KB of memory 10 dedicated to pattern matching state machines (the amounts of memory can vary). Any query that does not fit within the memory limits is distributed across multiple TEs 4. Each program consists of a sequence of custom instructions generated by the compiler. Pattern matching state machines, on the other hand, consist of sequences of transition rules. Each transition rule is of the form <current state, accepting state?, any character?, not character?, input character, next state, consume character?>. More details are provided in the appendices hereto. In some embodiments not all of these transition rules may be needed, e.g. “not character?” may not be needed

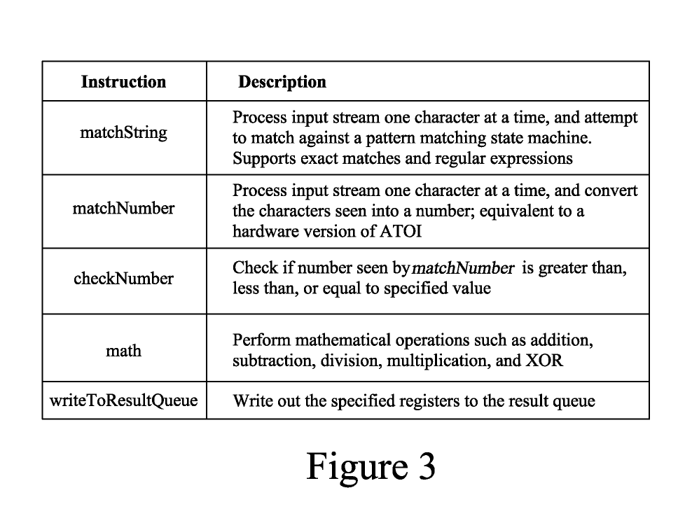

2) Instructions Supported: FIG. 3 provides high-level descriptions of the major instructions supported.

Each program that runs on a TE 4 is made up of a sequence of instructions, with the most notable instructions being matchString and matchNumber. Both instructions analyze the input stream one character at a time. Detailed descriptions of all instructions are provided in the appendices hereto.

matchString matches a specified string (represented by a corresponding pattern matching state machine) against the input stream. The pattern matching state machines, and therefore the instructions, support both exact string matches and regular expressions. The instruction advances the pattern matching state machines to its next state every cycle based on the current state and next input character seen. The pattern matching state machine indicate a match upon entering an accepting state. The pattern matching state machine also supports state transitions that do not consume input characters; such transitions help identify the end and beginning of adjacent fields in the input stream.

The matchString instruction exits when a mismatch occurs or a match is found. If a mismatch is found, the program rejects the input line, notifies the aggregator 6 via status registers 12, and requests the aggregator 6 for a new line to process. If a match is found, the TE 4 writes out information specified in the program to result queues 14 from where the results are read by the aggregator 6. The information written out by matchString includes pointers to the matching string in the input line. Alternatively, for a bit implementation, match string may output the ID of the state that just matched.

matchNumber analyzes the input streams for numbers, and identifies any number within the stream as a number and determines the value of that number (stored to an output operand register). Some other instructions associated with matchNumber include checkNumber which verifies whether the number seen on the input stream is greater than, less than, or equal to a specified value, and math which can perform mathematical operations on the number derived from the input stream (including, for example, instruction hashing, CRC generation, or signature generation using the observed value(s)).

The aggregator 6 serves two major functions. First, the aggregator 6 post-processes the results written to the result queues 14 generated by the TEs 4. Second, the aggregator 6 controls a pointer into the input stream for each TE 4, and allocates lines to the TEs 4 for processing. To improve performance, multiple input lines are stored in a buffer 16 described below. As TEs 4 process lines and write their results out to the result queues 14, the aggregator 6 pops processed lines, moves the pointers into the buffer 16, and thereby controls the addition of new unprocessed lines to the buffer. By controlling the position of each TE's pointer into the input line buffer, the aggregator 6 maintains loose synchronization across the TEs 4. Stated another way, the aggregator 6 ensures that a TE may only run ahead of another TE by no more than the depth of the input line buffer 16. The aggregator 6 can be implemented in custom hardware, or can be implemented in software on a simple general-purpose processor. We assume the latter below. An extension to the ISA of the general purpose core facilitates interaction between the aggregator 6 and the result queues.

The input line buffer 16 is responsible for storing multiple log file entries read from memory. The buffer interfaces with memory via the memory interface unit. The memory interface unit sends out requests for cache line sized pieces of data from memory. The memory interface unit uses the aggregator's TLB for its addressing-related needs. Whenever an entry in the input line buffer 6 becomes available, the memory interface unit sends out a read request to the memory hierarchy. When the requested data is returned from memory, the vacant entry in the input line buffer 6 is written to. Pointers into the input line buffer from the aggregator 6 control the requests for new data from the input line buffer.

Each logical TE 4 can write its results (i.e., registers) to its result queue 14. The result queue 14 is read by the aggregator 6 for subsequent processing of the entries. Once all the results associated with an input line have been read and processed by the aggregator, the pointers from the aggregator 6 into the input line buffer 16 are updated, and the entry can be overwritten by fresh lines from memory.

A few adjustments can be made to the design to improve performance.
A content addressable memory (CAM) to store the pattern matching state machines. The CAM enables access to matching transition rules within one cycle (as opposed to having to iterate through all the potentially matching transition rules over multiple cycles).
Provision to allow for multiple characters to be evaluated per cycle. This feature is relevant for exact string matches, and uses comparators that are multiple bytes wide.
Accelerator provides for the acceptance or rejection of a line by the TEs 4 at an early cycle.
   Once the accept or reject decision has been communicated to the aggregator 6, the TE 4 proceeds to work on the next available line. However, this feature depends upon the quick detection of end of line characters in the input line buffer. This may be assisted through the use of N bytewide comparators, where N is equal to the width of the memory transaction size in bytes (i.e. cacheline size in bytes).
Pattern matching state machines can be stored more efficiently using bit-split state machines as proposed by Tan and Sherwood. The accelerator uses this algorithm to store exact match state machines.

More generally the TEs 4 may be programmed to select on a per-character basis which one of a plurality of different query algorithms to use, e.g. per-character pattern matching (e.g. Aho-Corasick), per-bit pattern matching (e.g. Tan and Sherwood) or a CAM based algorithm where multiple patterns are matched in parallel.

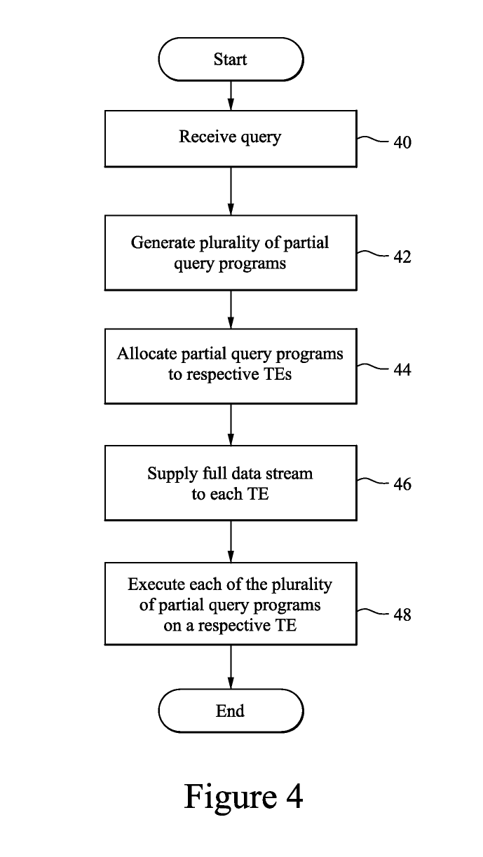

FIG. 4 schematically illustrates a flow diagram showing how a received query is divided (sharded) into a plurality of partial query program. At step 40 a query to be performed is received. Step 42 divides then receives query into a plurality of partial query programs. These partial query programs are selected such that they will have program instruction and state machine requirements which can be accommodated by an individual TE. Each of these partial query programs receives the full set of input data (the full stream of input characters) as an input to its processing. This technique can be considered to provide Multiple Program Single Data operation (MPSD). The multiple programs are different from each other in the general case, but together combine to provide the overall operation of the query receives at step 40. At step 44 the partial query programs are allocated to respective TE's for execution. At step 46 the full data stream is supplied to each TE. Accordingly, each TE receives the same input data. An individual TE may early terminate its access to the full stream of input data and so may not actually process all of the stream of input data. Nevertheless, the same full set of input data is available as an input, if required, by each of the TEs. At step 48, each of the plurality of partial query programs is executed by a respective TE using the full data stream supplied at step 46. It will be appreciated that in practice the steps 46 and 48 may be conducted in parallel with the full data stream being supplied in portions as the plurality of partial query programs are undergoing continuing execution by their respective TEs.

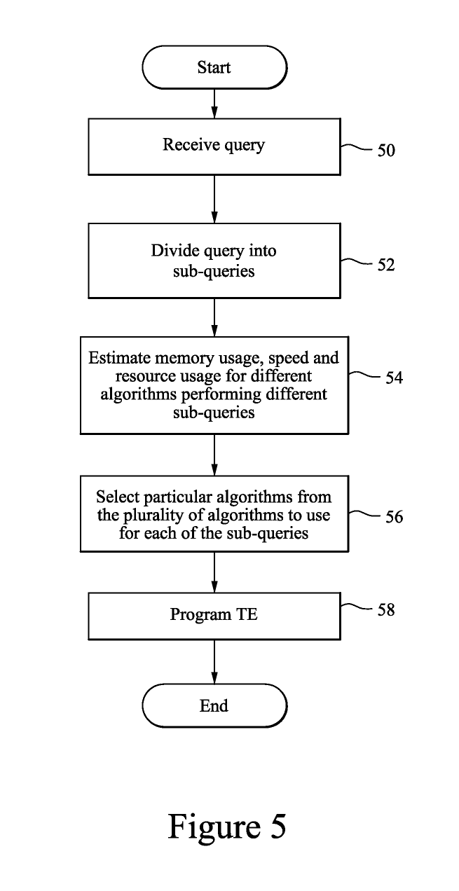

FIG. 5 is a flow diagram schematically illustrating how different query algorithms may be selected to perform different portions of a query operation. As previously mentioned the different query algorithms may be selected for use with different portions of an overall query to be performed Each of the different algorithms can have associated advantages and disadvantages. As an example, the per-character pattern matching may be relatively storage efficient and be capable of being used to express a wide variety of different types of query, but may suffer from the disadvantage of being relatively slow to execute and potentially require the use of a hash table in order to access the data defining its state machines. A per-bit pattern matching algorithm may also be storage efficient and may be faster than a per-character pattern matching algorithm. However, a per-bit pattern matching algorithm is generally not amenable to performing queries other than those corresponding to exact matches. A content addressable memory based algorithm may have the advantage of being fast to operate, but has the disadvantage of a high over head in terms of circuit resources required and energy consumed.

Returning to FIG. 5, step 50 receives the query to be performed. This may be a full query or a partial query that has already been allocated to a particular TE. Step 52 divides the query received into a plurality of sub-queries whose performance for each of a plurality of different possible implementation algorithms may be evaluated. At step 54 the performance characteristics (e.g. memory usage, speed, resource usage etc.) for each of the plurality of different candidate algorithms in performing the different sub-queries is determined. Step 56 then serves to select particular algorithms from the plurality of algorithms to use for each of the sub-queries. The selection may be made so as to meet one or more of a program storage requirement limit of the TEs, a processing time limit and/or a hardware resources limit of the one or more TEs (e.g. CAM storage location availability). At step 58 the TE concerned is programmed. The algorithm used may be varied as the TE progresses through the portion of the query processing allocated to it. The algorithm used may be varied on a per-character (or per group of character) basis as the sequences of characters are queried. In practice, the switching between the algorithms is likely to be less frequent than on a per-character basis.

The stream of character data with which the present techniques operate may be unindexed data. Such data (e.g. an unindexed sequence of character data, unindexed log data etc) provides a difficult query target for convention query mechanisms and accordingly the present techniques may provide improved querying performance for such data.

The aggregating which is performed by the aggregator 6 may be performed as a single processing operation upon a plurality partial results as generated by each TE. For example, the aggregator 6 could OR together a large number of partial results, AND together a large number of partial results, perform a mathematical operation upon a large number of partial results, or some other combination of logical or other manipulations upon the results. The aggregator 6 performs such processing upon the partial results as a single process, e.g. executing a single instruction or a small number of instructions.

The buffer 16 of FIG. 2 may include a delimiter store. As data is stored into the buffer 16, delimiter identifying circuitry serves to identify data delimiters between portions of the sequenced data as it is loaded. The delimiters may, for example, be end of line characters or other characters which delimit portions of the sequence of data. These portions may be irregular in size. The delimiter store may be accessed by the aggregator 6 in order to determine the start of a next portion of the sequence of data to be supplied to a TE 4 when it completes processing the current portion it is operating upon. This can speed up the operation of accelerator 2 by avoiding the need to search through the sequence of data to identify the start and end of each portion of that data which needs to be supplied to a TE. Instead, the delimiters may be identified once at load time and thereafter directly referred to by the aggregator 6. As previously mentioned, the different TEs 4 are free to query different portions of the data within the buffer 16 within the limits of the data held within the buffer 16. This keeps the TEs in loose synchronization. The aggregator 6 stores a head pointer and a tail pointer. The head pointer indicates the latest portion of the full data stream which has been loaded by the memory interface unit into the buffer from the main memory. The tail pointer indicates the earliest portion of the sequence of data for which pending processing is being performed by one of the TEs. Once the tail pointer moves beyond a given portion, that portion is then a candidate for being removed from the buffer 16.

As mentioned above, the TEs 4 support a matchNumber instruction. This is a number match program instruction and serves to identify a numeric variable and to determine a value of that numeric valuable located at a variable position within a sequence of characters. The numeric variable may take a variety of forms. For example, it may be an integer value, a floating point value or a date value. Other forms of numeric variable are also possible. The output of number match program instruction may comprise a number value stored within a register specified by the number match program instruction. This may be a selectable output register.

The performance of the accelerator 2 is compared against CPU based solutions for a variety of benchmarks. In the experiments the datasets and queries presented by Pavlo and co-authors are used (A. Pavlo, E. Paulson, A. Rasin, D. J. Abadi, D. J. DeWitt, S. Madden, and M. Stonebraker. A comparison of approaches to large-scale data analysis. In Proceedings of the 2009 ACM SIGMOD International Conference on Management of Data, SIGMOD '09, 2009). The following tasks and datasets described below are considered and used to evaluate the design using simulator. The number of simulator cycles are counted for a task, and the time required calculated for the task assuming a frequency of 1 GHz (other frequencies could also be used).

The expected performance of the design as reported by the simulator is compared against the time measured for each task on a Xeon-class server. Since ‘awk’ provides the functionality most relevant to the queries below, we utilize ‘awk’ on the real machine.

A. Task 1: Selection

Pavlo et al.'s dataset for the selection task consists of documents with the following structure <Page Rank, URL, Duration>. As in Pavlo et al., the present test query takes the form of select ‘Page Rank, URL’ where ‘Page Rank>10’. The likelihood of a Page Rank being above 10, is almost 0.23%. Since the present design aims to rapidly reject or accept lines and then move to the next line. the last field in each line that needs to be evaluated plays an important role in the performance of the design. Therefore, the following considers the query, select ‘URL, Duration ’ where ‘Page Rank>10’ to evaluate a scenario where the last character of each line needs to be evaluated.

B. Task 2: Grep

For the ‘grep’ task, the dataset consists of multiple 100-byte lines. Each 100-character line consists of a 10 character unique key, and a 90-character random pattern. The 90-character random pattern is chosen such that the string being searched for only occurs once per 30,000 lines. The query for the accelerator 2 in this case is: select line where line==“*XYZ* ”. Note that for this query, all characters in a line will need to be evaluated if a match is not found.

C. Task 3: Aggregation

The aggregation task utilizes a dataset that consists of lines of the form <Source IP, Destination URL, Date, Ad Revenue, User, Country, Language, Search Word, Duration>. The task aims to calculate the total ad revenue associated with source IP, grouped by the source IP. Since the groupby functionality is something that the aggregator takes care of, the query for the text engines is select ‘Source IP, Ad Revenue’. Given the ad revenue value that gets returned to it, the aggregator can perform the groupby operation using hash-tables.

Illustrative Y Results

Preliminary results obtained by comparing the performance of the simulated design versus running ‘awk’ on a real machine for the tasks listed in herein are discussed. The accelerator's 2 ability to reject or accept a line early provides advantages. Additionally, the accelerator 2 when evaluating more than one character per cycle provides significant advantages compared to CPU-based solutions.

A. Task 1: Selection

Consider the results for the query, select ‘Page Rank, URL’ where ‘Page Rank>10’ for the selection task. Recall that the dataset for this query consists of documents with the following structure <Page Rank, URL, Duration>.

| | |
|---|---|
| Accelerator Runtime (s) | 0.02 |
| Awk Runtime (s) | 1.5 |
| Speedup | 92x |

Next, we consider the results for the query, select ‘URL, Duration’ where ‘Page Rank>10’.

| | |
|---|---|
| Accelerator Runtime (s) | 0.22 |
| Awk Runtime (s) | 1.5 |
| Speedup | 6.7x |

As shown in tables above (the precise values may vary depending upon the exact parameters used), the accelerator 2 shows almost a two orders of magnitude speedup compared to the CPU-based solution when Page Rank is selected. The main reason for the improved performance is the fact that the accelerator 2 is designed to reject or accept a line as soon as the last field that requires evaluation has been evaluated. Since only the first two fields need to be evaluated in this case, a line can be accepted or rejected as soon as the URL field has been completely seen. Further, since the likelihood of finding an acceptable Page Rank is only 0.23%, many lines are rejected as soon as the Page Rank field has been evaluated and found to mismatch.

However, in the case where Duration has to be selected, the third field has to be completely seen before any accept or reject decision can be made. Additionally, the likelihood of a line having an acceptable Duration value is almost 385 X the likelihood of finding an acceptable Page Rank. This, in turn, increases the number of characters that need to be evaluated.

B. Task 2: Grep

Next, the results for the query, select line where line==“*XYZ*”, for the grep task are considered. The dataset for this query consists of lines with 100-characters each. Each line consists of a 10 character unique key, and a 90-character random pattern.

| | |
|---|---|
| Accelerator Runtime (s) | 0.19 |
| Awk Runtime (s) | 0.41 |
| Speedup | 2x |

As with the second selection query, the grep query requires the entire line to be evaluated in the worst case. Since the likelihood of finding a matching a line is 1/30,000, most lines are read completely before being rejected. While the speedup value for the grep task is not very high, it needs to be noted that the pattern matching state machine for this task (query) is rather small. With large pattern matching states machines that do not fit within CPU caches, we expect the speedup afforded by the accelerator to be significantly higher.

C. Task 3: Aggregation

Finally, the results for the query, select ‘Source IP, Ad Revenue’ executed on a dataset of the form <Source IP, Destination URL, Date, Ad Revenue, User, Country, Language, Search Word, Duration> are considered (the precise values may vary depending upon the parameters used).

| | |
|---|---|
| Accelerator Runtime (s) | 0.01 |
| Awk Runtime (s) | 0.15 |
| Speedup | 15.7x |

Again, the feature that the accelerator can reject lines early provides a significant advantage, and the speedup compared to ‘awk’ running on a Xeon-core is almost 16.

Although illustrative embodiments have been described in detail herein with reference to the accompanying drawings, it is to be understood that the invention is not limited to those precise embodiments, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

We claim:

1. A method of processing data comprising the steps of:
receiving a query specifying a query operation to be performed upon a set of input data;
generating a plurality of partial query programs each corresponding to a portion of said query operation; and
executing each of said plurality of partial query programs with all of said set of said input data as an input to each of said plurality of partial query programs.

2. A method as claimed in claim 1, wherein said step of executing executes each of said plurality of partial programs with one of a plurality of programmable hardware execution units.

3. A method as claimed in claim 1, wherein said input data is an unindexed sequence of character data.

4. A method as claimed in claim 1, comprising the step of aggregating a plurality of partial results resulting from respective ones of said, partial query programs to form an aggregated result corresponding to a result of said query.

5. A method as claimed in claim 4, wherein said step of aggregating is performed as a single process upon said plurality of partial results.

6. A method of processing data comprising the steps of:
receiving a query specifying a query operation to be performed upon input data;
programming one or more hardware execution units to perform said query, wherein
said step of programming programs said one or more hardware execution units to use selected ones of a plurality of different query algorithms to perform different portions of said query operation upon different portions of said input data.

7. A method as claimed in claim 6, wherein said plurality of different algorithms comprise one or more of:
a per-character pattern matching algorithm using a character matching state machine representing a query operation to be performed with each sequence of one or more characters within a sequence of characters to be queried determining a transition between two states of said character matching state machine and each state within said character matching state machine corresponding a given sequence of received characters; and
a per-bit pattern matching algorithm using a plurality of bit matching state machines representing a query operation to be performed with each bit of each character within said sequence of characters to be queried determining a transition between two states of one said plurality of bit matching state machines and each state within said bit matching state machine corresponding a bit within one or more sequences of received characters; and
a content addressable memory based algorithm using a content addressable memory storing a plurality of target character sequences to be compared in parallel with one or more characters of a received sequence of characters.

8. A method as claimed in claim 6, wherein said one of more hardware execution units each comprise hardware circuits for performing any one of said plurality of different query algorithms.

9. A method as claimed in claim 6, wherein said step of programming selects which one of said plurality of different query algorithms to use on a per-character basis within a sequence of characters to be queried.

10. A method as claimed in claim 6, wherein said step of programming selects which of said plurality of different query algorithms to use so as to target one or more of:
a programming storage requirement limit of said one or more hardware execution units;
a processing time limit; and
a hardware resources limit of said one or more hardware execution units.

11. Apparatus for processing data comprising:
a memory to store a sequence of data to be queried;
delimiter identifying circuitry to identity data delimiters between portions of said sequence of data as said data is stored to said memory; and
a delimiter store to store storage locations of said data delimiters within said memory.

12. Apparatus as claimed in claim 11, comprising a plurality of hardware execution units to query said sequence of data stored within said memory, wherein said plurality of hardware execution units are free to query respective different portions of said sequence of data at a given time.

13. Apparatus as claimed in claim 12, wherein when a given one of said plurality of hardware execution units determines it has completed querying a portion of said sequence of data, a read of said delimiter store identifies a start of a next portion of said sequence of data to be queried by said given one of said plurality of hardware execution units.

14. Apparatus as claimed in claim 12, wherein said sequence of data stored within said memory is a part of a larger sequence of data and comprising management circuitry to manage which part of said larger sequence of data is stored within said memory at a given time, said management circuitry maintaining a pointer into said memory for each of said plurality of hardware execution units and including a head pointer to indicate a latest point within said larger sequence stored in said memory and a tail pointer to indicate an earliest point within said larger sequence already loaded to said memory for which processing by said plurality of hardware execution units is not yet completed, said management circuitry using said head pointer and said tail pointer to control loading data to said memory and removing data from said memory.

15. Apparatus as claimed in claim 11, wherein said data delimiters identity variable boundary locations between portions of said sequence of data to be separately queried.

16. Apparatus for processing data comprising:
programmable processing hardware responsive to a number match program instruction to identify a numeric variable and to determine a value of said numeric variable located at a variable position within a sequence of characters.

17. Apparatus as claimed in claim 16, wherein said numeric variable is one of:
an integer value;
a floating point value; and
a date value.

18. Apparatus as claimed in claim 16, wherein said programmable processing hardware is programmable to perform a query operation upon an unindexed sequence of character data.

19. Apparatus as claimed in claim 16, wherein an output of said number match program instruction comprises said number value stored within a register specified by said number match program instruction.

20. Apparatus as claimed in claim 16, comprising a plurality of instances of said programmable processing hardware to perform respective portions of a query upon said sequence of characters.
